(19) United States
(12) Patent Application Publication
(10) Pub. No.: US 2012/0055010 A1
(43) Pub. Date: Mar. 8, 2012

(54) MANUFACTURE OF COMPOSITE LIGHT DIFFUSING GLASS PANELS

(75) Inventors: Douglas I. Milburn, Sydney (CA); Allan Gordon Archie MacMillan, Marion Bridge (CA)

(73) Assignee: ADVANCED GLAZING TECHNOLOGIES LTD. (AGTL), Sydney, NS (CA)

(21) Appl. No.: 12/877,391

(22) Filed: Sep. 8, 2010

(51) Int. Cl. B23P 17/00

(52) U.S. Cl. 29/527.1

(57) ABSTRACT

Disclosed is a method of making a composite light diffusing panel, comprising providing a first glass lite with a light transmissive fabric layer applied to surface thereof; applying a primary sealant to the surface of the first glass lite using an edge referencing method to meet horizontal dimensional requirements; mounting a spacer to the primary sealant on the surface of the first glass lite to form a first subassembly; applying a primary sealant to the surface of a second glass lite also using an edge referencing method to form a second subassembly; and topping the second subassembly atop the first subassembly to form an assembled composite light diffusing panel. Also disclosed is a flipping apparatus that can be used in the method.

### FIELD

The present invention relates to composite light diffusing glass panels. More specifically, the present invention relates to the manufacture of composite light diffusing glass panels.

### BACKGROUND

Insulated glass panels are commonly used as building facades. Referring to FIG. 1, conventional insulated glass panel manufacturing starts with two glass lites 10, 12 that have been cut to size, L. A spacer 14 of a suitable thickness to maintain overall glass panel thickness is fabricated to the correct length and width, typically about a half inch smaller than the length and width of the glass in order to allow space for sealant 16. The spacer 14 is generally made of metal or plastic tubing filled with desiccant 15, or a polymer foam with embedded desiccant (plastic and polymer typically have a metal film applied to act as a barrier against moisture vapor diffusion). Assembly includes laying the spacer 14 on a first glass lite, aligning it by hand to maintain, an approximately uniform gap, G, around the edges, then placing the top lite of glass on the assembly in approximately alignment with the components below, and then applying a final sealant 16 to fill the gap around the edge.

In this type of panel, the spacer is often ‘dry’ and is simply laid on the first glass lite with the second glass lite placed on top, and final sealant applied (typically a hot melt or a two part silicone). Once the sealant has cooled or cured, the panel is fully assembled. This conventional method has some drawbacks: a) the spacer can contact glass directly which causes thermal bridging, especially with use of a metal spacer which was until the late 90's the only practical choice; and b) part of the sealant must be of low moisture vapour transmittance which really limits a manufacturer to using butyl (great MVTR) or polysulfide (not as good MVTR), both of which are weak physically and prone to failure from pressure cycling.

If the final sealant used has low resistance to moisture vapour diffusion (such as silicone), then a ‘primary sealant’, usually butyl, is applied to the spacer before the panel is assembled. If a dual seal system is used (primary sealant on spacer and a final or secondary sealant around the perimeter), or if one wishes to have the spacer stand off the glass for thermal or physical durability reasons, it is not really practical or possible to apply both sealants to a finished panel. Rather they are built as per FIG. 2a. In this case, as in the case of a dry spacer, alignment of the two glass lites 20, 22 and the spacer 23 with a butyl primary sealant 24 of the panel during assembly is not critical and a hand-laid, eyeball-aligned process is completely suitable. This is because the panel is tolerant to dimension variations as long as the gap doesn't get so small that there is insufficient space for sealant 24. In such an embodiment, the spacer usually has dessicant 17 built into the spacer.

In contrast, composite light diffusing glass panels that use foam tape require more precise alignment, as illustrated in FIG. 2b. Composite light diffusing panels use a fabric layer 31 between the two glass lites 30, 32. The use of fabric 31 provides different, desirable aesthetic effects and improved distribution of natural light inside buildings. To manufacture such a composite light diffusing panel, lites of glass are cut to size, Lglass, and a piece of fabric is cut to size, Lfabric. The fabric 31 is carefully adhered to the glass, taking care to maintain a uniform gap between the edges of the glass and fabric, on all four sides. The spacer 35 is then carefully placed on the glass 30, 32 using a primary sealant, and a final or secondary sealant 34 is applied (not seen in FIG. 2b).

In the embodiment shown, the primary sealant is foam tape 33, which presents manufacturing challenges. Referring to FIG. 2ci, the spacer 35 is placed taking care to maintain a close relationship between the foam tape 33 and the edge of fabric with a gap, G that is between 0″ and 1/32″. Referring to FIG. 2cii, if the gap, G is less than zero (i.e. tape overlaps fabric) the tape bond will be imperfect and the spacer 35 is in danger of shifting once the unit is clamped into a framing system. As a result, the fabric 33 will shift and cause wrinkling. Referring to FIG. 2ciii, if the gap is too large (the 1/32″ maximum is a useful upper bound although slightly arbitrary) then a visible bright corona can be observed from inside the building when in direct sunlight.

It is important to note that this alignment requirement does not exist in the manufacture of conventional insulated glass units because there is no fabric in conventional panels. With use of a fabric on at least one lite however, care must be taken to avoid undesirable aesthetic effects. Accordingly, the relative placement of the fabric and spacer must be accurate with respect to the size of the glass lites. If the fabric is too large, too small or is placed incorrectly, then undesirable aesthetic effects can result. Once the use of a fabric is introduced, care must be taken to achieve both vertical and horizontal dimensional requirements.

It should be noted that throughout this application, the terms “horizontal” and ‘vertical” are defined as illustrated in FIG. 3. As can be seen, horizontal and vertical are defined with respect to the glass 39 lying flat on a table. Horizontal directions are the two transverse directions along the surface of a glass lite. In the industry, these horizontal dimensions are referred to as ‘height’ and ‘width’ (owing to the fact that the units will most likely be installed in a vertical or sloped orientation. Vertical direction as shown in the drawing is in the through-unit direction, and is typically referred to as ‘thickness’.

The present Applicant has previously come up with a partial solution to this problem. One such composite light diffusing panel is disclosed in US Patent Publication Number 20060291200 published on Dec. 28, 2006. In accordance thereto, the adhesive is applied to the fabric itself in a manner such that the adhesive is not visible nor does it affect light diffusing properties. This allows the fabric to maintain its position once it is applied to the glass. However the teachings of this patent application only address placement of the fabric, and maintenance of that position in the center region of the panel. The teachings of this patent application do not deal with or provide any guidance on the challenges faced with respect to the horizontal geometry particularly at the edges.

Another company, Edgetech IG, supplies an edge referenced applicator tool for applying its flexible foam-based spacer, which is similar to foam tape. Edge referencing methods use tools that rely on an edge for alignment. However this method only teaches to use an edge alignment tool for placing foam-based spacer with respect to the glass edge on one lite of glass. It does not teach how to align a second lite of glass. And aligning a second glass lite atop the first glass lite is very difficult; dimensional requirements cannot easily be met using the Edgetech approach.

### SUMMARY

The present Applicant faced a problem in the manufacturing of composite light diffusing glass panels. In order to meet the stringent horizontal alignment requirements of the previous method of manufacturing, one would have to control size of fabric, placement of fabric, size of spacer, and placement of spacer, so that the sum of variance from design specification varies less than 1/32″. In practice, given that spacer, glass, and fabric may be up to 12′ in dimension, making it difficult to meet these conditions in a production.

Thus disclosed is a composite light diffusing panel manufactured using an edge referenced method for meeting horizontal tolerance requirements. In broad terms, embodiments of the invention uses a layer of primary sealant placed on each lite of glass, in conjunction with the use of a conventional spacer. According to further teachings of the invention, the primary sealant is not applied to the spacer itself, but to the surface of the glass lite. This creates the precise alignment required between primary sealant and fabric at the surface of the glass. The system is robust with respect to tolerating the dimensional variance that is an inherent feature in placing the fabric on a glass lite along with a spacer, and then a second glass lite with primary sealant applied thereon to provide a finished composite light diffusing glass panel. In accordance with the teachings of this invention, the primary sealant can be either foam tape or butyl.

Embodiments of the invention also contemplate a method and apparatus for precisely aligning a second glass lite atop the first glass lite to form a fully assembled composite light diffusing glass panel.

Thus, according to one aspect, the invention provides a method to efficiently and repeatably produce glass units that have alignment of glass edge, primary sealant, and fabric to within required tolerances of −0, + 1/32″.

There are many advantages in using this alignment method. First, the alignment method produces alignment within required tolerances in a quick and efficient manner. It also may be carried out by ordinary plant workers who have been trained in the method, who can consistently achieve better results than highly skilled craftsman using previous methods, and is thereby compatible with modern volume production and quality assurance methods. Finally, the configuration of the edge has been purposely designed as part of this invention to be robust, in that it is capable of tolerating small positional displacement of the spacer (these commonly occur in real installations due to imperfect clamping or loading due to the weight of the unit acting on small points due to setting blocks, or large internal pressure variations), without transmitting that displacement to the edge of the fabric which would cause wrinkling which is a serious aesthetic defect. This resistance to wrinkling has been a serious problem with this class of product.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1 illustrates a conventional insulated glass panels using only a final sealant;

FIG. 2a illustrates a conventional insulated glass panel using both a primary sealant and a final sealant;

FIG. 2b illustrates manufacture of a conventional composite light diffusing panel;

FIG. 2ci illustrates the gap requirement for the manufacture of a composite light diffusing panel of FIG. 2b;

FIGS. 2ci, 2cii and 2ciii illustrate unacceptable gaps in the manufacture of a composite light diffusing panel of FIG. 2b;

FIG. 3 illustrates the terms “horizontal” and ‘vertical” dimensional requirements as used throughout this application;

FIGS. 4a, 4b, 4c, 4d, 4e illustrate steps of a first method of manufacturing a composite glass panel in accordance with the teachings of this invention;

FIG. 5a illustrates a tool that can be used to trim fabric in accordance with the teachings of the method of FIGS. 4a, 4b, 4c, 4d and 4e;

FIG. 5b illustrates use of the tool of FIG. 5a in the step of FIG. 4c;

FIG. 6a illustrates a tool that can be used to apply foam glazing tape in accordance with the teachings of the method of FIGS. 4a, 4b, 4c, 4d and 4e;

FIG. 6b illustrates how tape is dispensed from the tool of FIG. 6a;

FIG. 6c illustrates use of the tool of FIG. 6a;

FIGS. 7a, 7b, 7c and 7d illustrate the steps a second method of manufacturing a composite glass panel in accordance with the teachings of this invention;

FIG. 8a illustrates a tool that can be used to apply butyl in accordance with the teachings of the method of FIG. 7b;

FIG. 8b illustrates use of the tool of FIG. 8a in a side view;

FIG. 8c illustrates a front view of FIG. 8b;

FIG. 9 illustrates a flipping apparatus that can be used to manufacture glass panels;

FIG. 10 illustrates a top view of the flipping apparatus of FIG. 9, showing additional details;

FIGS. 11a, 11b, 11c and 11d are simplified drawings of the flipper of FIG. 9, illustrating a side view of using the flipping apparatus; and

FIGS. 12a, 12b and 12c are simplified drawings of the flipper of FIG. 9, illustrating a top view of using the flipping apparatus.

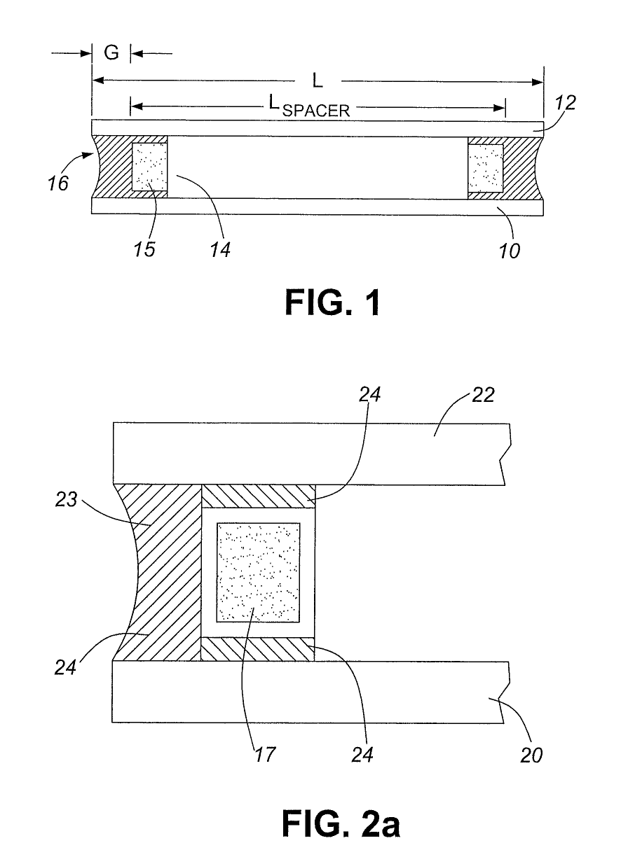

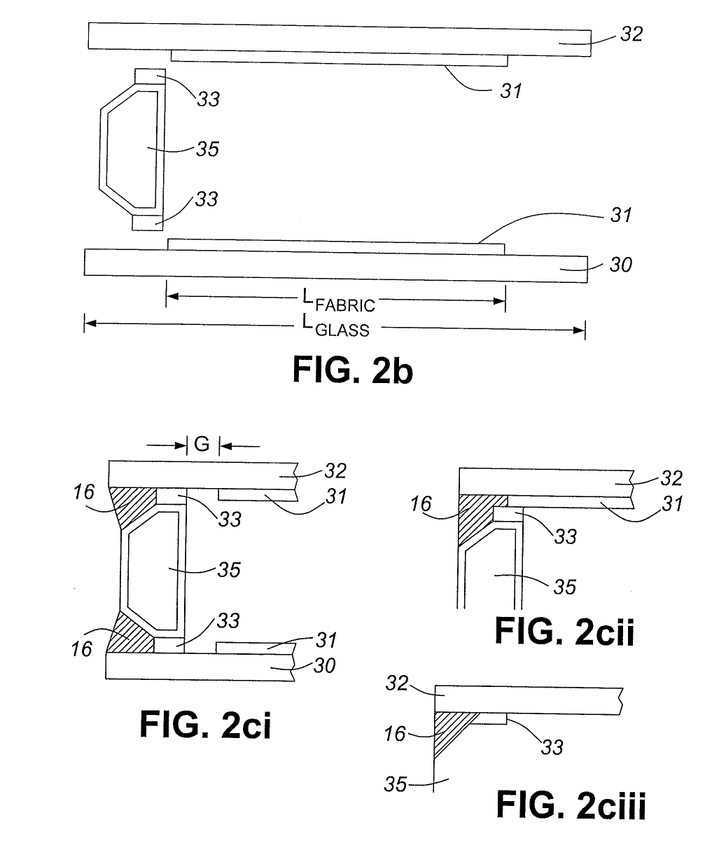

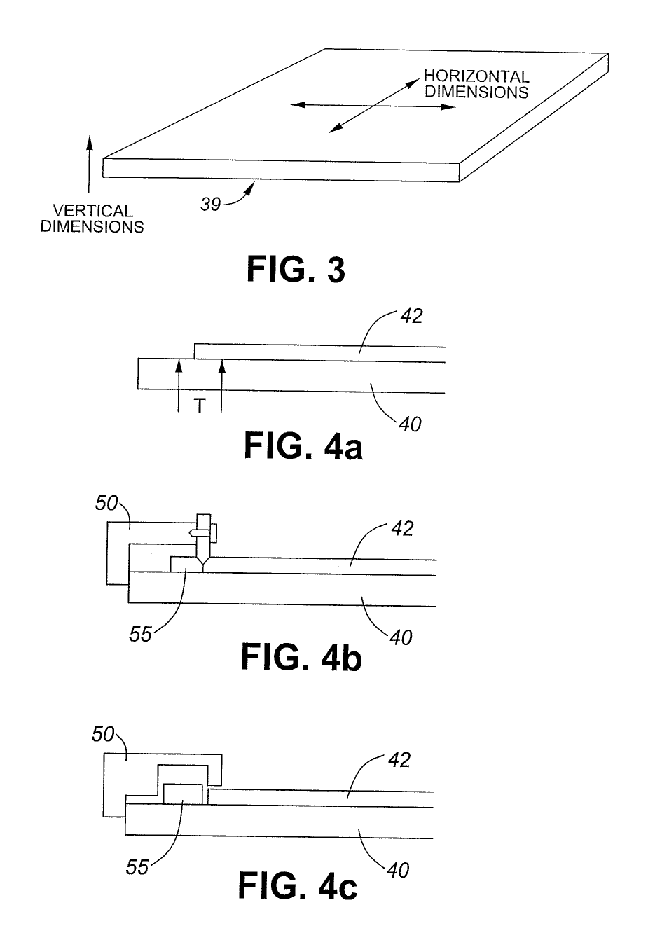

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

According to teachings of this invention, there are two embodiments of a method to manufacture a composite light diffusing panel. Each method revolves around and is specific to the type of primary sealant used. There are both some similarities and some differences between the embodiments.

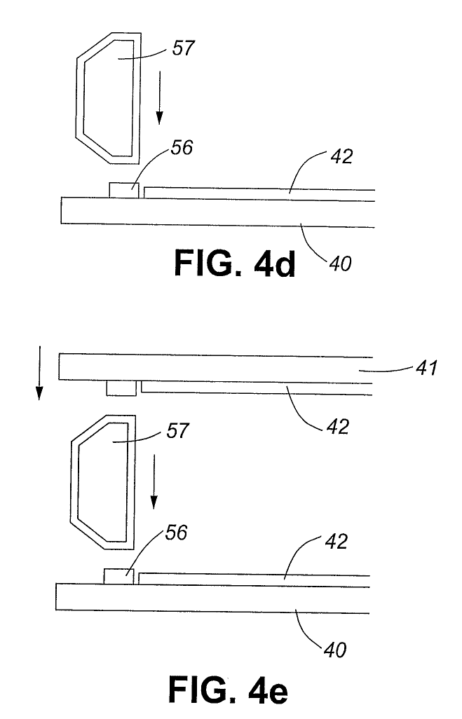

Referring to FIGS. 4a, 4b, 4c, 4d, 4d and 4e, there is illustrated steps of a first method of manufacturing a composite glass panel in accordance with the teachings of this invention. In this first method, foam tape (primary sealant) is used to adhere the spacer to the glass lite

Referring to FIG. 4a, first, lites of cut-to-size glass 40, 41 are cleaned. The fabric 42 is cut to size, accounting for a trim allowance, T, of two times half the tape width (i.e the tape width). Laminating adhesive (not shown) is applied to the fabric 42 and the fabric 42 is placed on the glass lite 40 in a wrinkle free manner. This could be done according to the teachings of US Patent Publication Number 20060291200. The fabric 42 is aligned so that the gap is roughly even all the way around. This step is dimensionally tolerant as the sum of positional and size variation of the fabric may be half the tape width (typically ¼″) which can be achieved. The trim allowance should not extend past the target position of the foam tape, as the acrylic adhesive that is applied to the fabric would contaminate the glass surface with respect to bonding of final sealant, whereas it is compatible with the acrylic adhesive on the glazing tape.

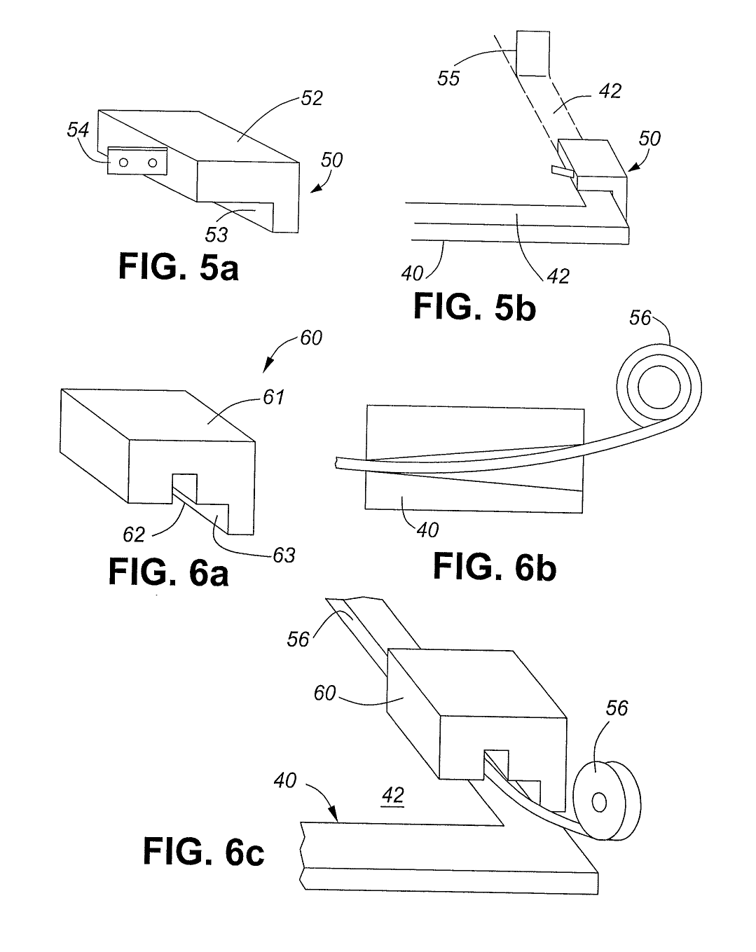

Referring to FIGS. 4b and 4c, the fabric 42 is trimmed all the way around using an edge referenced tool 50, such as the one illustrated in FIG. 5a. The fabric 42 is trimmed to remove excess fabric 55 using a knife blade 51 attached to a guide block of plastic 52 machined to provide an edge reference 53 in order to maintain a constant alignment between position of the cut and the edge. The block 52 has a sharp cornered razor blade 51 mounted on one side so that it protrudes just below the edge of the major working flat surface of the block, as seen in FIG. 5b. It also has a protrusion 54 from the bottom which rides on the edge of the glass, creating alignment. In this way, one can maintain tolerances of less than 1/64″ or better with this method, with respect to the edge of the glass.

Referring to FIG. 4d, adhesive foam glazing tape 56 is applied on the glass 40, also using an edge referenced tool 60, such as the one seen in FIG. 6a. The tool 60 comprises a small block 61 as shown. The block 61 has an edge guide 63 and a tape guide channel 62 that tapers in depth so the tape 56 can enter above the glass (FIG. 6b, which is a side view of the dispensed tape), and then be pushed down onto the glass as it exits as the block 61 slides along the glass (FIG. 6c). This tool 60 is machined in order to act as a guide for tape application. This is a departure from conventional methods where the tape is placed on the spacer directly. The inventors were surprised to discover an advantage of placing tape on the glass, not on the spacer. In this way, tape can easily be applied to a positional tolerance of +/− 1/32″ relative to edge of glass, thereby maintaining tight relationship to the edge of the fabric which is also tightly referenced to the edge of glass.

Thus, the requirement for precise placement between tape and fabric is achieved by the teachings of embodiments of this invention. This method could be considered a ‘double edge referenced’ method, which creates a precision relationship between the fabric and the glass edge, and between the tape and glass edge, thereby leading to a relationship between fabric to tape. One can gain great precision (0.010″ or less if done properly) in, for example, the position of a tape edge, or a veil edge relative to the edge of glass. Therefore by edge referencing both, the worst case variation is on the order o 0.020″, and the two components are lined up well within a tolerance band of overlap 0″, gap 1/32″. The inventors have learned that if the tape overlaps the fabric adhesion, the physical integrity of the unit is compromised and wrinkling may occur. If the gap is bigger than 1/32, a visible bright corona becomes obvious and interferes with the visual appearance and therefore function (glare reduction) of the unit.

The foam tape has a release strip on one side which is left in place on the subassembly. At this point, there are two optional steps. A first optional step involves trial fitting the spacer prior to removal of the release strip, and if it fits, then to proceed. The release strip is removed from tape, and the spacer is applied to the foam tape. This is possible because the system is tolerant to variation in position such as would be experienced by simple hand placement of spacer as is done in most conventional vision glass panel manufacturing plants.

A second optional step involves trial fitting the second glass-tape-fabric subassembly before removing release strip from tape on this second assembly. The release strip is removed from the tape on a similarly constructed glass-fabric-tape subassembly, and placed on top of the five sided box such that tape contacts the spacer. Again this is achievable due to tolerance to positional variation as per the previous optional step.

As seen in FIG. 4d, a spacer is then applied on top of tape 56.

This provides a first subassembly of glass panel-fabric-spacer. A second subassembly is created in a similar fashion, but it should be noted that the second subassembly does not necessarily require a fabric. As seen in FIG. 4d, the second subassembly is capped on top of the first glass lite-fabric-spacer subassembly. The method in which this is accomplished is discussed in detail below. To finish the unit, a final sealant (typically silicone) is applied around outer edges between glass lites and spacers in a conventional fashion to result in a fully assembled composite, light diffusing glass panel.

For example only, the glass lites are typically 4 mm to 10 mm in thickness and can be clear or colored. Typical heights and widths range from 1′ to 12′. The fabric and adhesive are as known in the art. The tape is preferably standard UV stabilized polyolefin or acrylic foam, coated with non yellowing acrylic adhesive on both sides, one side having a release strip to facilitate unrolling and to protect upper tape surface until assembly. Typically the tape is ¼″ wide, 1/16″ thick. Capitol Tape is one supplier of a tape that can be used.

Embodiments of this method provide a number of advantages over conventional methods. The extra step of trimming of the fabric relative to the edge of the glass and then applying the spacer on top of the tape for each of the two glass lites to create two subassemblies, surprisingly provides the advantage of higher tolerances to dimensional variations between the spacer and foam tape that has been created by precisely aligning tape and fabric and glass edge.

This method is tolerant to dimensional variations typically encountered in manufacturing, and the method allows faster assembly by removing need for fit adjustment during assembly. The method also ensures robust product by eliminating fabric/tape overlap since the fabric is less subject to wrinkling. Also, a uniformly small gap is ensured between tape and fabric for minimal corona.

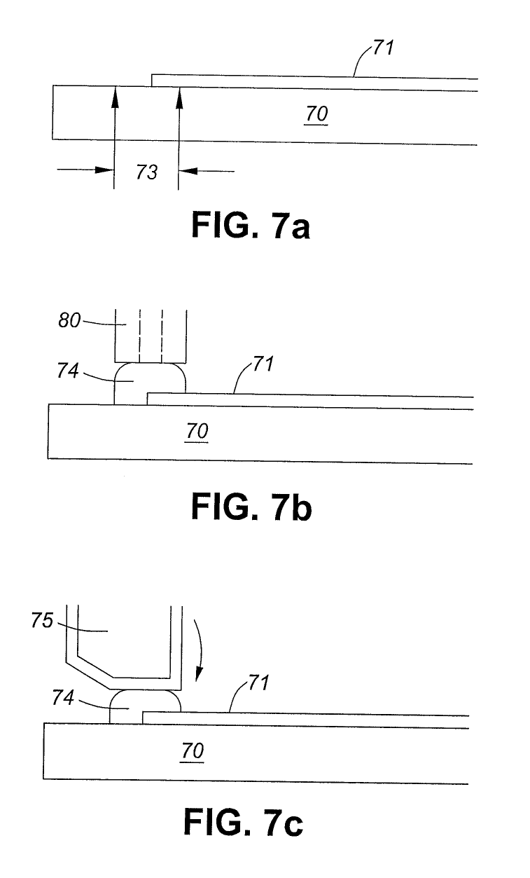

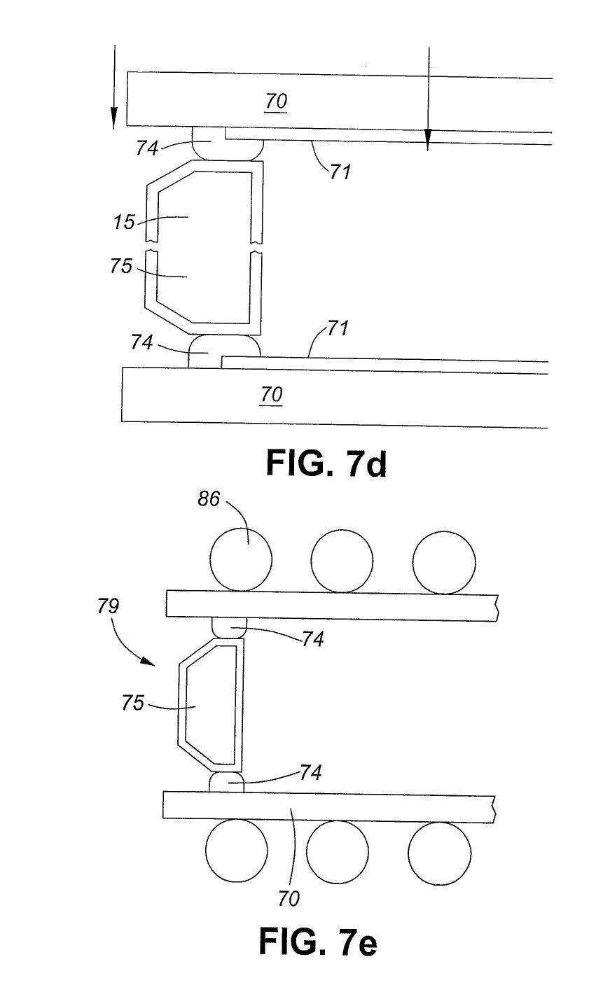

Embodiments of this invention contemplate a second method using extrusion of hot melt butyl, as seen in FIGS. 7a, 7b, 7c, 7d and 7e. As seen in FIG. 7a, one starts with a cut-to-size glass 70. The fabric 71 is cut to open an aperture plus two times one half of design width of butyl strip. The fabric is coated with adhesive (not shown), and applied to the first glass lite 70. The fabric 71 is positioned so that the edge of the fabric is approximately in the middle of the target zone 73 for the butyl beads. Placement of fabric 71 is quite tolerant to dimensional variation, as the edge can range from glass-centre side of butyl to within ⅛″ of the glass-edge side of butyl, or ⅛″ tolerance for a ¼″ strip of butyl. This is readily achievable in a manufacturing situation.

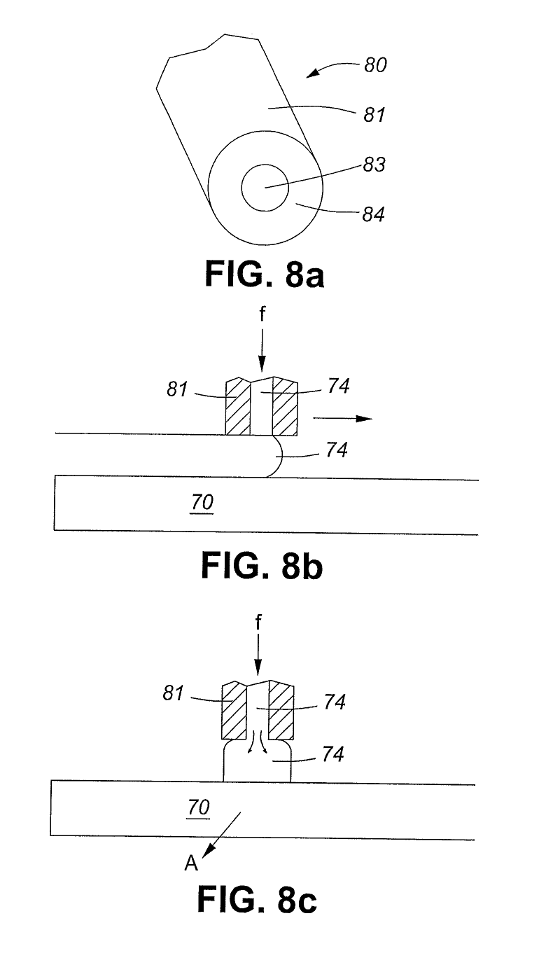

As seen in FIG. 7b, then a hot melt butyl strip 74 is placed on the glass lite, preferably using an edge referenced tool 80. The butyl 74 is extruded from a cylindrical nozzle 81 with a flat edge 84 similar to that shown in FIG. 8a over the target zone. The nozzle 81 is a pipe with appropriate inner diameter (such as ¼″) and sufficient wall thickness (such as ¼″) to serve as a flow channel 83. As seen in FIGS. 8b (side view) and 8c (front view), hot melted butyl 74 flows through the tube (indicated by arrow F) which is moving over the glass in the direction of arrow A, and the flat edges 84 of the tube 81 shape it into a bead as shown. Nozzle height, speed, and flow rate are controlled in order to control width and height of the extruded butyl. The path of the nozzle is controlled so that it follows at a constant offset relative to the edge of the fabric.

As seen in FIG. 7b, the butyl 74 must overlap the fabric 71. The required dimensional relationship between the butyl and the fabric edge is not as tight as it is for foam tape and fabric because there is no gap and corona as long as the butyl does indeed overlap the fabric. Because of this, the butyl does not need to be applied using an edge referenced method, as other positional alignment techniques may meet the ⅛ tolerance requirement. However, edge referencing is a suitable method for guiding the nozzle when applying butyl. As seen in FIG. 7c, the spacer is then placed on butyl to provide an assembled glass lite, butyl, fabric first subassembly.

Referring to FIG. 7d, a second assembled glass lite-butyl-optional fabric subassembly 78 is produced in a similar manner as the first subassembly. This second subassembly is placed on top of the first subassembly in a method described below.

The fully assembled panel 79 is then pushed through a hot roller press 86 to melt and bond butyl to the spacer, and pressed to finished dimension. This step of forming the assembled panel uses standard equipment and is a standard process known in the art. Then final sealant is applied as known in the art.

The capital equipment requirements in using butyl are higher than using foam tape, as the hot melt apparatus includes a pump, heated delivery system, heated nozzle, and gantry of typical 5×12′ size with control of nozzle in 3-D (to provide height compensation as the glass is typically not completely flat).

The use of foam tape resists spacer movement because the bottom bond between foam tape and glass does not shear when spacer receives a lateral thrust, but rather, the foam elastically deforms via shearing, thereby tolerating forces via small movements. When butyl is used, the butyl does shear with zero velocity at bottom of layer like a fluid, so the spacer can move but the fabric remains in place with the bottom layer of the butyl. Thus wrinkling of fabric due to displacement of fabric edge as a result of spacer movement is avoided.

It should be noted that in both methods, the second glass lite either can have a fabric adhered thereto or not. It should also be noted that the Applicant has tested both systems for robustness, and both can resist forces of 500 lbs applied by air cylinder without inducing wrinkles in the veil.

The methods in accordance with the teachings of this invention have at least one surprising step in common: they both place the primary sealant (tape in the first method and butyl in the second method) on the glass lite itself rather than on the spacer. This has the critical effect of allowing tight positional alignment to be achieved on a consistent basis during mass production.

It is Applicant's understanding that the industry places the primary sealant on the spacer rather than the glass lite for a number of reasons. Primary sealant (almost always butyl) is applied to spacer, and the butyled spacer is dropped onto the first glass lite with a second glass lite subassembly stacked on top. The fully assembled panel is hot rollered to melt/bond/press to final thickness (in the case where butyl is used as the primary sealant), and final sealant (silicone for best strength) is then applied over gap.

Reasons for the status quo of applying primary sealant to spacer has to do with convenience—if applying primary sealant to the glass lite, one would have to either move a large heavy piece of glass lite through a conventional stationary extruder nozzles, or move nozzles around a large piece of glass. In either case, it has been more convenient to slide a light, linear, spacer through a relatively small stationary butyl extruder, and then drop the butyled spacer onto the glass lite.

Also, one must consider that when making vision glass (without fabric), there is a tolerance of slight dimensional misalignment between spacer and glass edge as mentioned above, so the spacer can be laid by hand, and manually tweaked so that the gap simply looks uniform to the eyeball. Thus there was no pressure in this art to consider moving towards the more difficult process of applying primary sealant to the glass lite directly.

However in the case of composite light diffusing glass panels, it is important to address the alignment between the fabric and spacer for the reasons described above. The present Applicant previously manufactured the panels by applying foam tape to the spacer (to form a thermal break and to hold their units together so that they could be moved while the silicone structural sealant dries). This was done by carefully by controlling the size of the fabric and the spacer, and then laboriously trial fitting the spacer onto the glass-fabric subassembly, adjusting by hand. However to make it work, a gap of 0 to 1/32″ needs to be maintained all the way around, which means controlling the size variation of spacer and fabric to well less than that. Even with precise cutting gear, it is inherently impossible to do so because of stretch, twist, and differential thermal expansion of the fabric to control the size of a 12 ft piece of fabric or spacer that accurately. Plus the fitting was ‘arts and crafts’, trying to wrestle slight bows and twists in and out of spacer to force it to fit.

Eventually, the present inventors discovered that they could extrude hot butyl as a primary sealant right on the glass, over the edge of the fabric, thereby allowing tolerance of almost the whole width of the bead of butyl. Testing has shown that: a) movement of the spacer (which occurs often in field installations due to lateral forces from incorrect clamping, framing, or setting blocks) would not cause wrinkling because the butyl simply shear-deforms as a fluid with zero velocity at the glass surface and thereby will not cause wrinkles which are a visual defect that will result in the customer demanding replacement of the unit; and b) that several butyls that, even when heated to 90° C. where the butyl softens, the butyl would not bleed or wick through the fabric which would also cause failure in the minds of the customer. Based on these favourable results, the inventors built prototype gear, and built and tested prototype units and were greatly surprised by the results of this process.

The inventors then had a second epiphany leading them to try applying foam tape directly to the glass lite. Using foam tape is a little less desirable because it leaves a gap since the tape is rigid and therefore can't partly ride up on the fabric nor will it shear like a fluid in response to spacer movement but rather will drag the edge of the fabric inducing wrinkles. However by using edge referenced hand tools as described, the inventors discovered the fabric can be trimmed and tape applied while maintaining tight tolerance necessary to reliably maintain a gap of 0- 1/32″. The dimensions controlled by the processes as described in accordance with the teachings of this invention are a distance from edge of glass (same as butyl)—1% tolerance on 1″ is 0.010, whereas in the original process the gap depends on error on the overall dimension of the unit which is up to 12 ft, or 144″-1% error is 1.5″, and therefore this is much more challenging.

Another problem that the present inventors faced was that, even using edge referenced methods to create a glass lite-fabric-spacer subassemblies as described in accordance with the present invention, aligning the two subassemblies to the create a glass panel must meet dimensional restrictions as well. Any errors in either perpendicularity of spacer or size difference between glass makes perfect alignment impossible. Thus, embodiments of this invention also contemplate a method to top the first subassembly with a second subassembly.

In other words, even having two separate subassemblies manufactured with acceptable alignment, the inventors struggled to find a way to create a fully assembled panel in a manner tolerant of a reasonable degree of misalignment. This is difficult to achieve in normal manufacturing conditions because of dimensional variations in the glass, and difficulty of precisely aligning the second subassembly with the first subassembly.

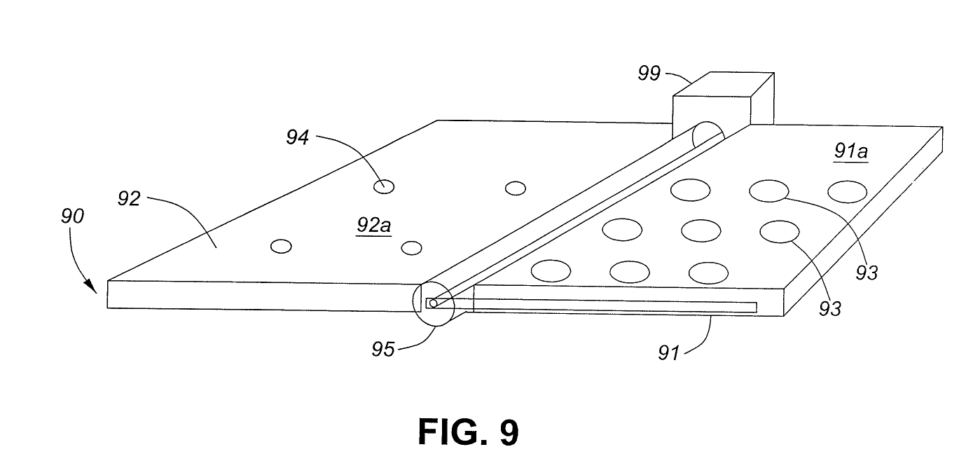

Referring to FIG. 9, the present inventors then came up with a method and apparatus to precisely align the first subassembly to the second subassembly to form a fully assembled composite light diffusing panel in accordance with the teachings of this invention.

Thus embodiments of this invention contemplate the use of a flipping apparatus. Broadly, the flipping apparatus 90 in accordance with the teachings of this invention comprises a first plate 91 with numerous suctions cups 93 on the upper surface 91a thereof. It should be noted that although suction cups 93 are illustrated as a preferred embodiment, any type of securing mechanism could be used. A second plate 92 has an upper surface 92a defined by either rollers or a smooth surface with numerous holes 94 through which pressurized air is emitted, in order to allow large lites of glass to be easily moved with minimal friction. The first and second plates 91, 92 are joined via a rotational axis 95 there between, which is driven by drive 99.

When the flipping apparatus 90 is not in use, the first and second plates 91, 92 lie in the same plane with their upper surfaces 91a, 92a facing upwards. In this rest position, the first and second subassemblies can be loaded, one subassembly to one plate. The subassemblies could be manufactured by any method, either as contemplated by the teachings of this invention or by any other method.

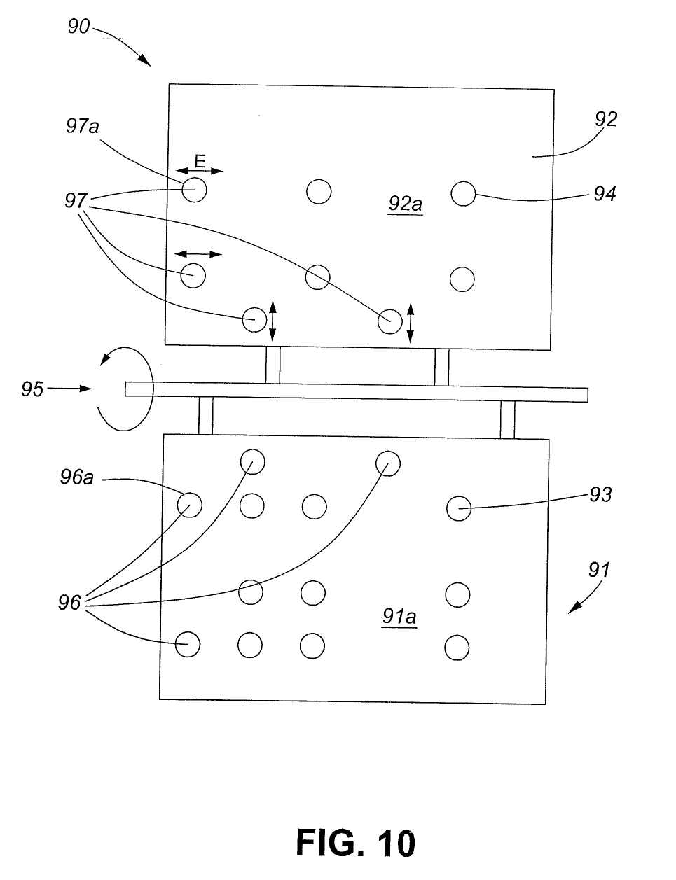

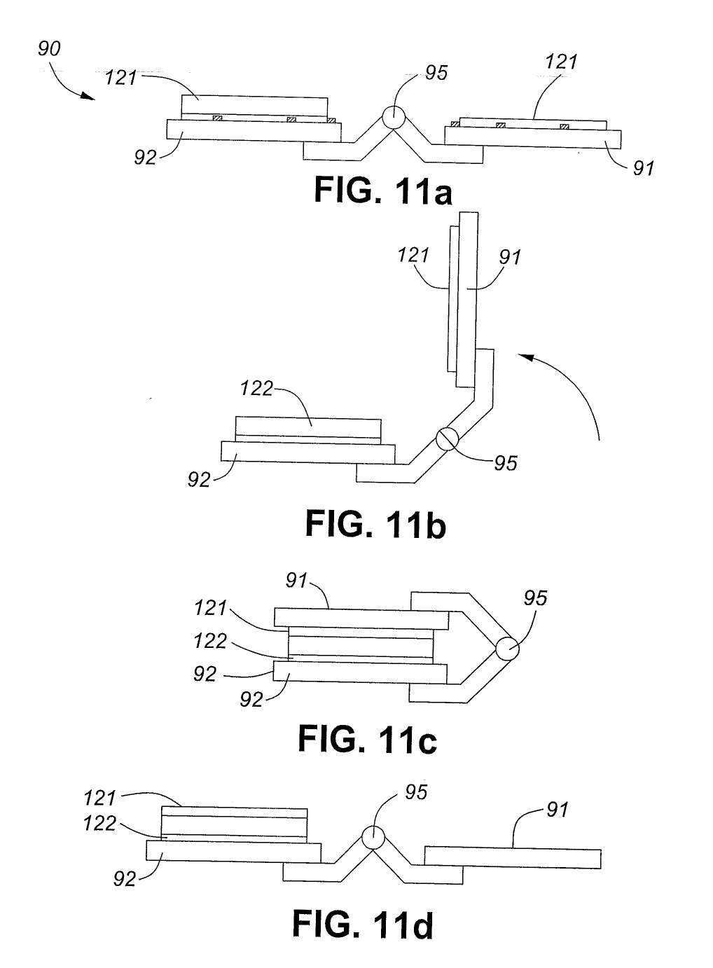

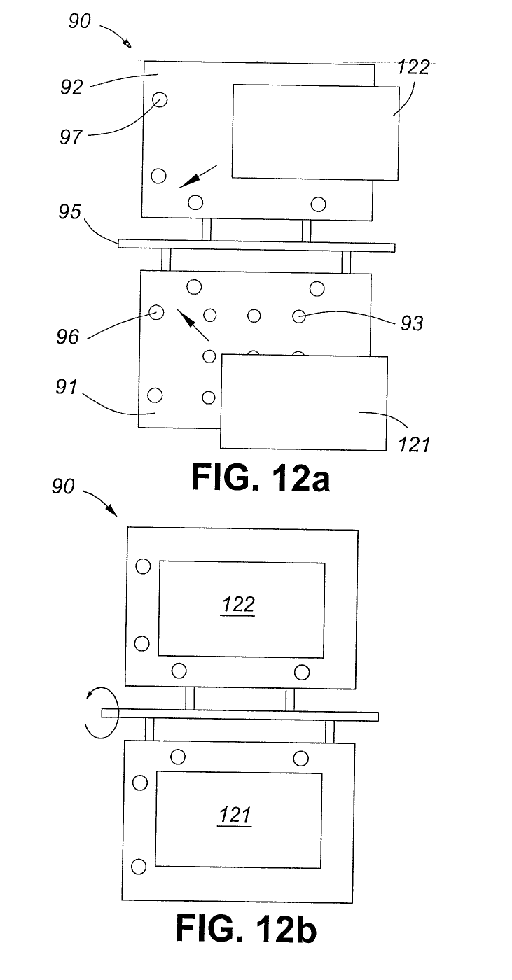

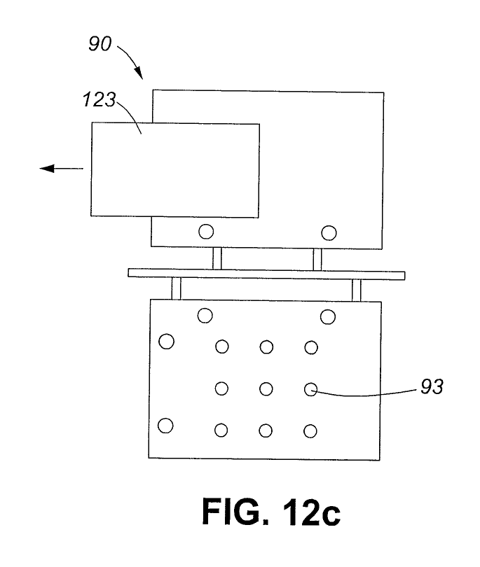

Referring to FIG. 10, each plate 91, 92 has two sets of stops 96, 97, consisting of at least two pins 96a, 97a that can be retracted below each respective surface 91a, 92a. The stops 96, 97 are used to precisely position the subassemblies, with respect to the plates 91, 92, in the horizontal plane. Each set of stops 96, 97 defines two adjacent perpendicular sides. Stops 97 on fixed plate 92 are adjustable, while stops 96 on rotating plate 91 are fixed. Referring to FIGS. 12a, 12b and 12c, there is shown a simplified illustration of a method of using a flipping apparatus 90 in a top view. FIGS. 11a, 11b, 11c and 11d illustrate a side view of the method of FIGS. 12a, 12b and 12c. During loading (FIG. 12a), the stops 97 are put in position, and each subassembly 121, 122, is positioned such that two the sides are firmly up against the stops. Referring to FIGS. 12b and 11a, this ensures that the subassemblies are positioned precisely. Referring to FIG. 11b, the rotating plate 91 then rotates about axis 95 so that after the flipping, the two subassemblies are in precise alignment relative to one another. Once the subassemblies 121, 122 are loaded, the flipping apparatus 95 is operated so that the first plate 91 with the first subassembly loaded thereon is flipped upwards via the rotational axis 95, through a 90° angle (FIG. 11b), and settling back down after rotating a full 180° (FIG. 11c). During this rotation, the securing mechanism 93 keeps the subassembly in a fixed, secured position. In this flipped position, the first plate 91 is now resting atop the second plate 92 with its upper surface 91a with the suction cups 93 facing downwards. In this way, the second assembly is placed atop the first subassembly.

Rotating plate 91 then rotates back to its rest position as seen in FIGS. 12c and 11d. Since stops 97 on the fixed plate 92 have means to provide fine positional adjustment, this allows a calibration to be carried out during a trial fit step. In practice, it is only necessary to perform this fine adjustment once or twice during a production shift.

For the first plate with the suctions cups, the subassembly is loaded onto the suction cups. For the second plate, the subassembly is loaded directly onto the upper surface thereof. In both cases, the subassemblies are loaded with the spacers facing upwards.

A flipping apparatus in accordance with the teachings of this invention can be used in the manufacture of any type of glass panel, not just composite light diffusing glass panels. However due to the high precision alignment needed for composite light diffusing glass panels (as discussed in detail above), the flipping apparatus taught herein is most useful in the manufacture of this type of panel.

Numerous modifications may be made without departing from the spirit and scope of the invention as defined in the appended claims.

What is claimed is:

1. A method of making a composite light diffusing panel, comprising
providing a first glass lite with a light transmissive fabric layer applied to surface thereof;
applying a primary sealant to the surface of the first glass lite using an edge referencing method to meet horizontal dimensional requirements;
mounting a spacer to the primary sealant on the surface of the first glass lite to form a first subassembly;
applying a primary sealant to the surface of a second glass lite also using an edge referencing method to foam a second subassembly; and
topping the second subassembly atop the first subassembly to form an assembled composite light diffusing panel.

2. The method of claim 1, wherein the primary sealant is foam tape.

3. The method of claim 2, further comprising the step of trimming the fabric using an edge referencing method before the step of applying a primary sealant to the surface of the fist glass lite, wherein the referenced edge for the trimming step is the edge of the first glass panel.

4. The method of claim 3, wherein the step of trimming is done using an edge referenced trimming tool, comprising: a plastic block with an outwardly extending razor blade, and a protrusion which rides along the edge of the glass lite during use to create alignment.

5. The method of claim 3, wherein in the step of applying a primary sealant to the surface of the first glass lite, the referenced edge is the edge of the glass lite and wherein the foam tape does not overlap the fabric.

6. The method of claim 2, wherein the step of applying a primary sealant is done using an edge referenced tool, comprising: a plastic block having an edge guide and a tape guide channel that tapers in depth such the tape can enter above the glass, and then be pushed down onto the glass as it exits as the block slides along the glass.

7. The method of claim 1, wherein the step of topping is done using a flipping apparatus.

8. The method of claim 2, wherein the primary sealant is extruded butyl.

9. The method of claim 8, wherein in the step of applying a primary sealant to the surface of the first glass lite, the referenced edge is the edge of the first glass lite.

10. The method of claim 9, wherein the step of applying a primary sealant is done using an edge referenced tool, comprising a nozzle with a pipe such that hot melted butyl flows there through as the tool is moving over the glass lite.

11. A method of making a composite light diffusing panel comprising
providing a first glass lite with a light transmissive fabric layer applied to surface thereof;
trimming the fabric using an edge referencing method, wherein the referenced edge is the edge of the first glass panel.
applying foam tape to the surface of the first glass lite using an edge referencing method to meet horizontal dimensional requirements, wherein the foam tape is referenced to the edge of the glass such that the foam tape does not overlap the fabric;
mounting a spacer to the foam tape on the surface of the first glass lite to form a first subassembly;
applying foam tape to the surface of a second glass lite also using an edge referencing method to form a second subassembly; and
topping the second subassembly atop the first assembly to form an assembled composite light diffusing panel.

12. The method of claim 11, wherein the step of topping is done using a flipping apparatus.

13. A method of making a composite light diffusing panel comprising
providing a first glass lite with a light transmissive fabric layer applied to surface thereof;
applying extruded butyl directly to the surface of the first glass lite using an edge referencing method to meet horizontal dimensional requirements, wherein the extruded butyl is referenced to the edge of the fabric;
mounting a spacer to the extruded butyl on the surface of the first glass lite to form a first subassembly;
applying extruded butyl to the surface of a second glass lite also using an edge referencing method to form a second subassembly; and
topping the second subassembly atop the first subassembly to form an assembled light diffusing panel.

14. The method of claim 13, wherein the step of topping is done using a flipping apparatus.

15. A flipping apparatus used in the manufacture of glass lite panels, the flipping apparatus comprising:
a first plate with an upper surface;
a second plate with an upper surface, the upper surface of the second plate having a securing mechanism thereon; and
a rotational axis between the first and second plates;
wherein in a rest position, the first and second plates lie in the same horizontal plane;
wherein in use, a first subassembly of the glass lite panel loaded atop the upper surface of the first plate, and a second subassembly of the glass lite is loaded atop the upper surface of the second plate such that the securing mechanism secure the second assembly is place; and
wherein the second plate with the loaded first subassembly thereon is rotated via the rotational axis 180° to rest atop the first plate, so that the first assembly is aligned atop the second subassembly to form a glass lite panel.
